(19) United States
(12) Patent Application Publication
(10) Pub. No.: US 2008/0050968 A1
(43) Pub. Date: Feb. 28, 2008

(54) CABLE CONNECTOR

(76) Inventor: Che-Chia Chang, Jung-He City (TW)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/831,984

(22) Filed: Aug. 1, 2007

(30) Foreign Application Priority Data
Aug. 28, 2006 (CN) 200610037327.1

(51) Int. Cl. H01R 13/648

(52) U.S. Cl. 439/607

(57) ABSTRACT

The present invention provides a cable connector for connecting a mating connector, said cable connector comprising an insulating body, a plurality of signal contacts arranged in the insulating body, a ground element extend to a plurality of ground contacts interposed between each pair of signal contacts in the insulating body respectively, a cable having a plurality of conductive cores that are fixed to said signal contacts, a metal shell fastened and surrounded on the outer of the insulating body, a holding element for holding the ground element, the cable, and the metal shell and a jacket covering the back end of the insulating body, the metal shell and the front end of the cable, wherein the metal shell forms a pair of symmetric protrusions. Therefore, excellent fixation and electrical connection are formed between the cable connector with metal shell and the mating connector.

### BACKGROUND OF THE INVENTION

1. Field of the Invention

The present invention relates to a cable connector, more particularly, relates to a cable connector that used for external electrical equipments.

2. Description of the Related Art

As electronic technology develops, the serial ATA transmission interface are getting to replace the parallel ATA transmission to mainstream market due to use only one serial transmission pair to perform a transmission channel that is needed to high speed data processing and communication in cable connecting system of electronic equipments such as computers, servers etc.

Generally, a traditional cable connector comprises an insulating body and a cable, wherein the cable comprising a plurality of signal lines and ground lines that soldered with each of the signal contacts and ground contacts of an electrical connector, respectively.

Further, since serial ATA cable connectors are often used to transmit high frequency signals, the requirements of the shielding function to the structure of the connector is quite strict. Therefore, a metal shielding structure should be set between the insulating body and the outer layer of the cable connector.

When a cable connector plugged into a mating connector, it's caused a condition of bad contact due to an interstice exists between the inner wall of the mating connector and the outer metal shielding structure of the cable connector, and to decrease an effective shielding performance therebetween.

In order to achieve the metal shielding structure to fasten steadily a cable for preventing a malposition due to bend between each of transmission lines therein during manufacture, the applicant's U.S. Pat. No. 6,866,539 and U.S. Pat. No. 6,913,489 have described that they comprise a metal cover having a positioner for clamping out of a cable. The positioner having a holding wing will be adjusted as the size of the cable. Thus it is complex in designing.

### SUMMARY OF THE INVENTION

The object of the present invention is to provide a cable connector which can be assembled easily with a metal shell having an excellent shielding effect thereof.

The cable connector in accordance with the present invention comprises an insulating body, a plurality of signal contacts arranged in the insulating body along a front to back direction, a ground element extends a plurality of ground contacts which are interposed between each of signal contacts in the insulating body, a cable having a plurality of conductive cores that is fixed to said signal contacts, a metal shell fastened and surrounded the outer of said insulating body, a holding element for holding the ground element, the cable, and the metal shell, and a jacket is covered through the back end of the insulating body, the metal shell and the front end of said cable.

Wherein said metal shell forms a pair of symmetric protrusions along said front to back direction. Therefore, excellent fixation and electrical connection are formed between the cable connector having said metal shell and the mating connector.

### BRIEF DESCRIPTION OF THE DRAWINGS

FIG. 1 is a perspective view of the cable connector in accordance with the present invention;

FIG. 2 is a perspective view of the cable connector excluding the outer cover, in accordance with the present invention;

FIG. 3 is an exploded perspective view of the cable connector, in accordance with the present invention;

FIG. 4 is a fragmentary perspective view of the cable connector, in accordance with the present invention;

FIG. 5 is a perspective view of the cable connector and a mating connector, in accordance with the present invention;

FIG. 6 is the top view of the plugging between the cable connector and a mating connector, in accordance with the present invention;

FIG. 6A is the A-A line cross sectional view of FIG. 6; and

FIG. 6B is the B-B line cross sectional view of FIG. 6.

### DETAILED DESCRIPTION OF THE PREFERRED EMBODIMENTS

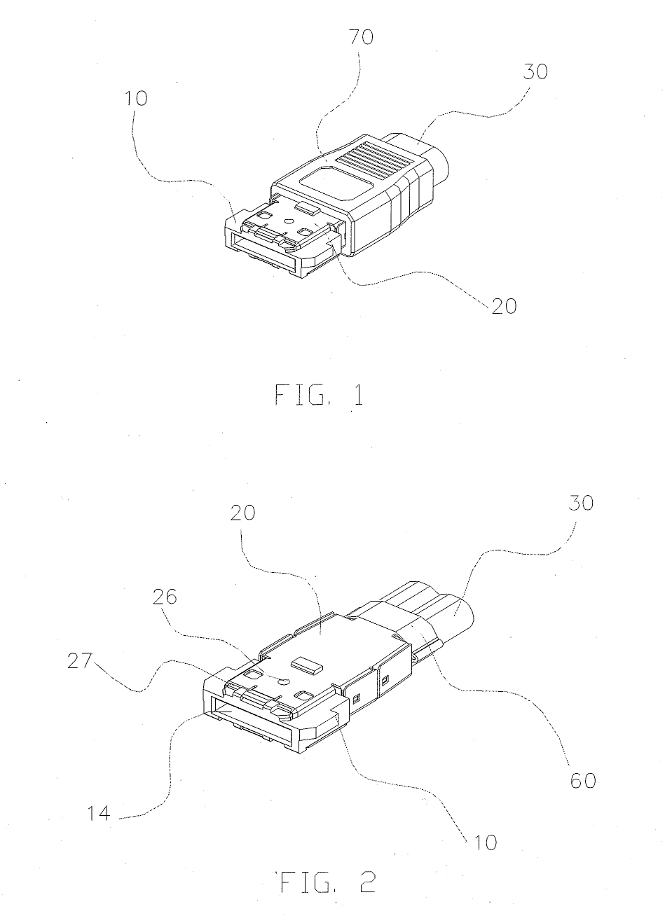

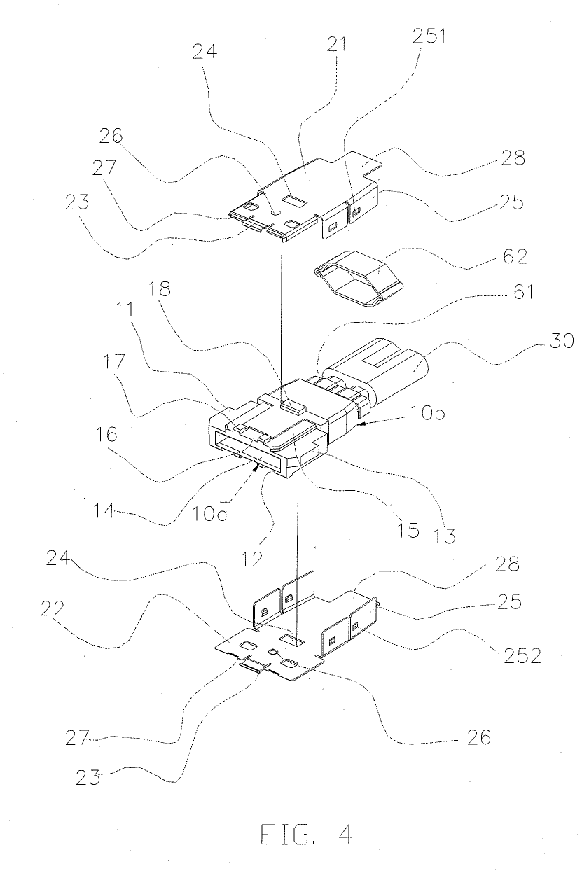

Referring to FIGS. 1, 2, 3 and 4, a preferred embodiment of the present invention is provided. The cable connector of the embodiment is a serial ATA connector that plugged with a mating connector device to provide electrical signal transmission; the cable connector comprises an insulating body 10, a metal shell 20, a cable 30, a plurality of signal contacts 40, a ground element 50, a holding element 60 and a jacket 70.

The insulating body 10 comprises a top wall 11, a bottom wall 12 corresponds to the top wall 11, and two of side walls 13 are adjoined to the top wall 11 and the bottom wall 12 respectively, all the walls surrounded and formed a rectangle cavity 14. For easy explanation, the front end of the cavity 14 is defined as an inserting port 10a, and its back end is defined as a cable connection port 10b. Both of the top wall 11 and the bottom wall 12 are forming a bulge 15 correspondingly. Each bulge 15 has a pair of first protuberances 17 adjoining to the inserting port 10a, and a concave 16 formed between the two first protuberances 17, and a second protuberance 18 formed near the cable connection port 10b thereon.

The metal shell 20 comprises a first shielding case 21 and a second shielding case 22 that can be engaged each other for holding and shielding the insulating body 10 along a front to back direction. Both of the first shielding case 21 and the second shielding case 22 have a tongue slat 23 corresponding to the concave 16 between the two first protuberances 17 respectively, and a perforation 24 is formed corresponding to the second protuberance 18. Further, there is a pair of side walls 25 beside the first shielding case 21 and the second shielding case 22 respectively. Each of side walls 25 have a fasten slot 251 or a fasten piece 252 that opposite between the first shielding case 21 and the second shielding case 22 engaging each other. In addition, a pair of symmetric protrusions 26 are outwardly formed on the first shielding case 21 and the second shielding case 22 along a front to back direction, and a pair of incline planes 27 are provided on both sides of the bulge 15 of the tongue slat 23 that near the inserting port 10a. Furthermore, the first shielding case 21 and second shielding case 22 are both provided with an extended section 28 that parallel extends from the cable connection port 10b.

The cable 30 comprises a plurality of signal transmission units 31, each of the signal transmission units 31 comprises a pair of signal lines 32 and an electrical cover layer 33 covered the signal line 32 in part, wherein each of the signal lines 32 has a conductive core 321 covered by an insulating layer 322.

Each signal contact 40 comprises a first inserting end 41 that exposed out the cavity 14 and a holding end 42 which extends outside of the back end of the insulating body 10. The holding end 42 are electrically connected to the uncovered area of the conductive core 321 of each signal line 32, wherein the connection of said holding end 42 and conductive core 321 may be used soldering or crimping.

Each ground element 50 has a contact portion 51, said contact portion 51 extends to form a plurality of ground contacts 52, said ground contacts 52 extends to form a second inserting end 53 opposite to said contact portion 51. Further, said contact portion 51 forms a plurality of concave section 511, each concave section 511 is used to contain each signal transmission unit 31, thus to make the contact portion 51 electrically contact said conductive cover 33 that covering the outside of said signal transmission unit 31.

The holding element 60 comprises a first positioning clamp 61 and a second positioning clamp 62 for holding the metal shell 20, the ground element 50, and the cable 30. Further, the jacket 70 is covered the back end of the insulating body 10, metal shell 20 and the outside of the front end of the cable 30.

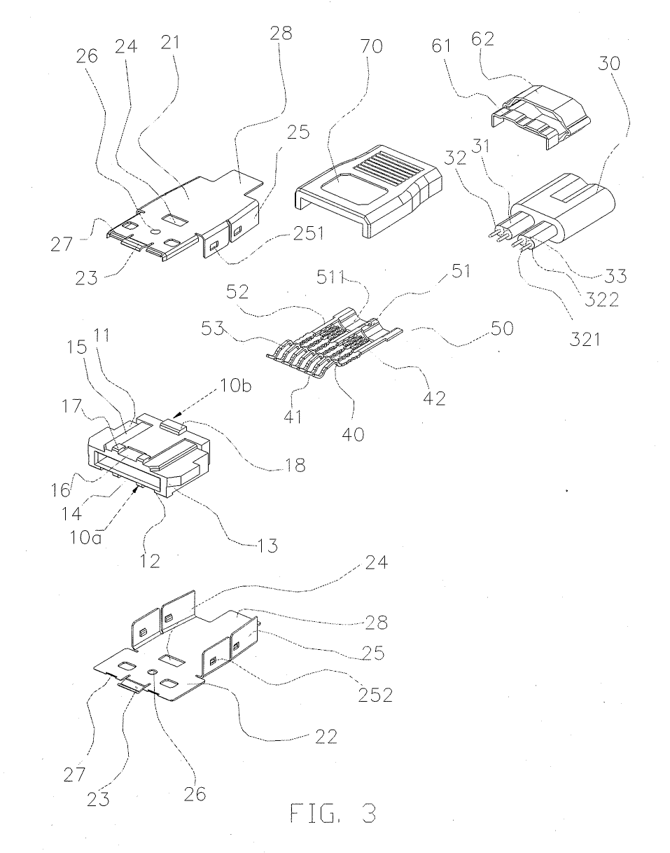

Referring to FIG. 2 to FIG. 4, each signal contact 40 is contained in the insulating body 10 along a front to back direction. The second inserting end 53 of the ground contacts 52 are contained in the cavity 14 respectively. Each of the ground contacts 52 thereof are interposed between each pair of signal contacts 40 in the insulating body 10. The first shielding case 21 and the second shielding case 22 are held by the fasten slot 251 and the fasten piece 252, and said perforation 24 engages the second protuberance 18 to make said first shielding case 21 and said second shielding case 22 for holding at the outside of said insulating body 10 along the front to back direction of the cavity 14. The tongue slats 23 of the first shielding case 21 and the second shielding case 22 are placed in the concaves 16 of said top wall 11 and said bottom wall 12 respectively, and the incline planes 27 lies on both sides of the first protuberances 17 of said concave 16. Wherein the signal transmission unit 31 of said concave section 511 that contains the ground element 50 is held by the first positioning clamp 61, then the second positioning clamp 62 holds and covers the extended sections 28 of the first shielding case 21 and the second shielding case 22 for holding the metal shell 20, the ground element 50 and the cable 30, then the jacket 70 covers the back end of said insulating body 10, the metal shell 20 and the outside of the front end of said cable 30.

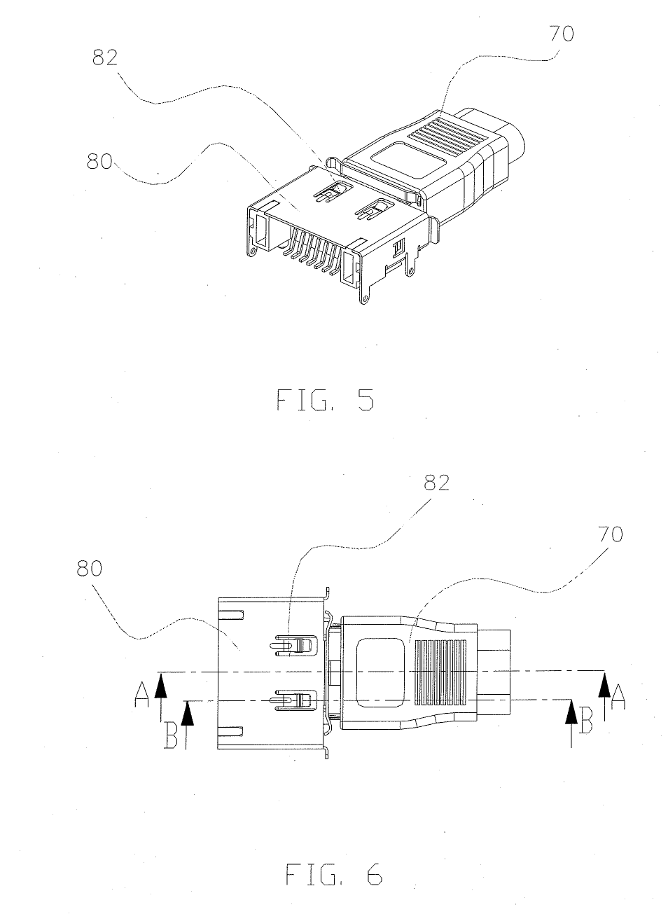

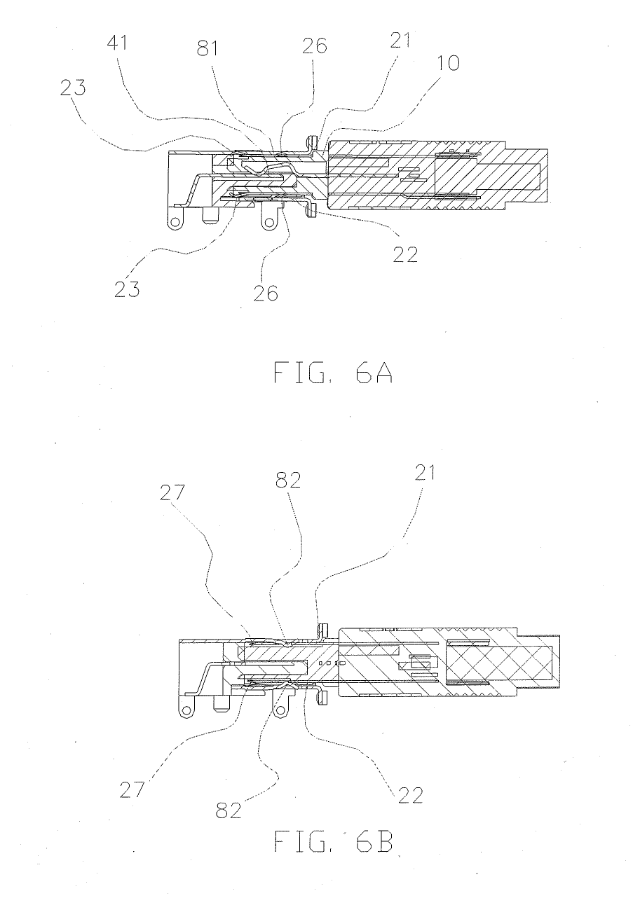

Referring to FIGS. 5 and 6, the plugging between the cable connector and a pair of mating connectors 80 is shown. The mating connectors 80 are fixed on the circuit board (not shown in the figure). During the initial inserting, the tongue slat 23 at the front end of the metal shell 20 contacts with the inner wall 81 of the mating connector 80, thus to form a ground loop due to the effect of electric charge discharge of the cable connector to guide to the chassis ground thereby enhance the quality of communicate quality. Further, the protrusions 26 of the metal shell 20 are provided to increase the contact area with the inner wall 81 of the mating connector 80 (as shown in FIG. 6A), thus to achieve excellent fixation and electrical connection between the cable connector and the mating connector. In addition, the inner wall 81 of the mating connector 80 is provided with a fasten elastic piece 82, the elastic piece 82 corresponds to the incline plane 27 lies on both sides of the first protuberances 17 fixed on the concave 16 of the metal shell 20. Therefore, it is easy for the cable connector to pass through the inserting port 10a to insert into the mating connector (as shown in FIG. 6B) without encumbrance.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A cable connector for connecting with a mating connector, said cable connector comprising:
an insulating body having a cavity;
a plurality of signal contacts arranged in the cavity of the insulating body;
a ground element extending a plurality of ground contacts, each ground contact interposed between each pair of signal contacts in the cavity of the insulating body respectively;
a cable having a plurality of signal transmission units, each unit having a pair of signal lines to respectively connect with each of the signal contacts and a conductive cover layer covered each of the signal lines in part, each signal line has a conductive core covered by an insulating layer; and
a metal shell fastened and surrounded the outer of the insulating body having a symmetric protrusions and a tongue slat corresponding to the mating connector.

2. The cable connector according to claim 1, wherein the metal shell comprises a first shielding case and a second shielding case engaged to each other for fastening with the insulating body vertically.

3. The cable connector according to claim 1, wherein each signal contact comprises a first inserting end exposed out the cavity and a holding end extends outside of the back end of the insulating body.

4. The cable connector according to claim 3, wherein the holding end are electrically connected to the uncovered area of the conductive core of each signal line.

5. The cable connector according to claim 4, wherein said holding end is connected with said conductive core by soldering.

6. The cable connector according to claim 4, wherein said holding end is connected with said conductive core by crimping.

7. The cable connector according to claim 1, wherein the metal shell comprises a pair of incline planes provided on both sides of the tongue slat.

8. A cable connector for connecting with a mating connector, said cable connector comprising:
an insulating body having a cavity;
a plurality of signal contacts arranged in the cavity of the insulating body;
a ground element extending a plurality of ground contacts, each ground contact interposed between each pair of signal contacts in the cavity of the insulating body respectively;
a cable having a plurality of signal transmission units, each unit having a pair of signal lines to respectively connect with each of the signal contacts and a conductive cover layer covered each of the signal lines in part, each signal line has a conductive core covered by an insulating layer;
a metal shell fastened and surrounded the outer of the insulating body having a pair of symmetric protrusions and a tongue slat corresponding to the mating connector;
a holding element for holding the ground element, the cable, and the metal shell; and
a jacket covering the back end of the insulating body, the metal shell and the front end of the cable.

9. The cable connector according to claim 8, wherein said metal shell comprises a first shielding case and a second shielding case engaged to each other for fastening with the insulating body vertically.

10. The cable connector according to claim 8, wherein each signal contact comprises a first inserting end exposed out the cavity and a holding end extends outside of the back end of the insulating body.

11. The cable connector according to claim 10, wherein the holding end are electrically connected to the uncovered area of the conductive core of each signal line.

12. The cable connector according to claim 11, wherein said holding end is connected with said conductive core by soldering.

13. The cable connector according to claim 11, wherein said holding end is connected with said conductive core by crimping.

14. The cable connector according to claim 8, wherein the metal shell comprises a pair of incline planes provided on both sides of the tongue slat.
